(19) United States
(12) Patent Application Publication
(10) Pub. No.: US 2010/0315249 A1
(43) Pub. Date: Dec. 16, 2010

(54) Method and Apparatus for Displaying Battery Remaining Time

(76) Inventor: Takumi Imai, Kawasaki-shi (JP)

Correspondence Address: DILLON & YUDELL LLP, 8911 N. CAPITAL OF TEXAS HWY, SUITE 2110, AUSTIN, TX, 78759, US

(21) Appl. No.: 12/777,380

(22) Filed: May 11, 2010

(30) Foreign Application Priority Data
Jun. 10, 2009 (JP) 2009-139561

(51) Int. Cl. G08B 21/00

(52) U.S. Cl. 340/636.12

(57) ABSTRACT

A method for displaying battery remaining time is disclosed. Initially, battery voltage, battery current and remaining battery capacity are initially detected. Then, a first battery remaining time at intervals of a first cycle period is determined based on the battery voltage, the battery current, and the remaining battery capacity. The first battery remaining time is updated and displayed on a display unit accordingly. In response to a power consumption change event occurs, a second battery remaining time at intervals of a second cycle period shorter than the first cycle period is determined based on the battery voltage, the battery current, and the remaining battery capacity. The second battery remaining time is then updated and displayed on the display unit accordingly.

### PRIORITY CLAIM

The present application claims benefit of priority under 35 U.S.C. §§120, 365 to the previously filed Japanese Patent Application No. JP2009-139561 entitled, “Electronic apparatus, method for displaying battery remaining time thereof, and computer executable program” with a priority date of Jun. 10, 2009, which is incorporated by reference herein.

### BACKGROUND

1. Technical Field

The present invention relates to an electronic apparatus in general, and in particular to an apparatus for displaying the remaining time of a battery.

2. Description of Related Art

In recent years, with the popularization of mobile computing, portable personal computers (portable PCs) having various sizes and functions have been developed. Examples of portable PCs include notebook PCs, subnotebook PCs, palmtop PCs, and Personal Data Assistants (PDAs).

A portable PCs typically incorporates an internal battery within its main body. Being powered by an internal battery, a portable PC can be utilized in environments such as on a train, where a commercial power source is not available. The internal battery typically uses a secondary battery that can be repeatedly utilized via charging.

Meanwhile, as a secondary battery that can be used in computers like portable PCs or consumer electronics, an intelligent battery incorporating an electronic circuit therein is attracting attention. An intelligent battery is able to inform the outside by an electronic circuit incorporated in the battery of the remaining capacity thereof. Therefore, the use of the intelligent battery as the secondary battery of a portable PC, for example, enables users to be pre-informed of shortages in the remaining capacity of the secondary battery when they are using their portable PCs in an environment where they cannot use a commercial power source, thus eliminating sudden shutdowns during the use of a portable PC.

In an intelligent battery, capacity information representing the total capacity of the battery is generally stored in advance, and the remaining capacity of the battery is obtained by subtracting the discharge amount obtained by integrating a discharge current value of the battery from the total capacity represented by the capacity information.

In addition, within an information processing apparatus powered by such a battery, the battery remaining time is calculated based on a remaining battery capacity and power consumption, and the battery remaining time is displayed on a display unit for the user's convenience. The battery remaining time is typically updated at intervals of a predetermined period.

However, since the displayed battery remaining time is updated only at the intervals of the predetermined period even when a user has changed power management settings, the user is unable to immediately check the battery remaining time that reflects the change in the settings.

Consequently, it would be desirable to provide an improved method for displaying the remaining time of a battery.

### SUMMARY

In accordance with a preferred embodiment of the present invention, battery voltage, battery current and remaining battery capacity are initially detected. Then, a first battery remaining time at intervals of a first cycle period is determined based on the battery voltage, the battery current, and the remaining battery capacity. The first battery remaining time is updated and displayed on a display unit accordingly. In response to a power consumption change event occurs, a second battery remaining time at intervals of a second cycle period shorter than the first cycle period is determined based on the battery voltage, the battery current, and the remaining battery capacity. The second battery remaining time is then updated and displayed on the display unit accordingly.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a laptop PC;

FIG. 2 is a block diagram of the hardware configuration of the laptop PC from FIG. 1;

FIG. 3 is a diagram showing a functional configuration related to update and display of the battery remaining time of the laptop PC from FIG. 1;

FIG. 4 is a graph illustrating the cycle period for calculating an average battery remaining time t_{BTAVE};

FIG. 5 is a flowchart illustrating a battery information display process at normal times that is performed by a battery information display program; and

FIG. 6 is a flowchart illustrating the battery information display process performed by the battery information display program when a power consumption change event occurs.

### DETAILED DESCRIPTION OF A PREFERRED EMBODIMENT

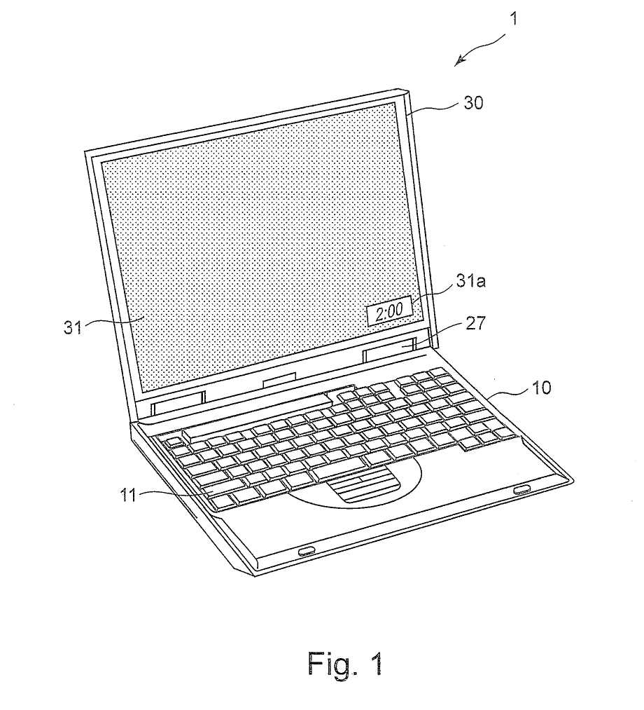

FIG. 1 is a diagram of a laptop PC. In FIG. 1, there are shown a laptop PC 1, a PC body portion 10, an input unit 11 having therein a keyboard and a slide pad, a display unit 30, a liquid crystal display panel 31, and hinge portions 27 supporting the display unit 30 so as to be pivotable relative to the PC body portion 10. The laptop PC 1 has a battery accommodated in the PC body portion 10 and can be powered by the battery. The liquid crystal display panel 31 updates and displays the battery remaining time 31a thereon at intervals of a predetermined cycle period. In the present embodiment, when a power consumption change event occurs, which can cause a great change in power consumption, in order to promptly inform users of its effect on the battery remaining time, the interval of updating and displaying the battery remaining time 31a is made shorter than that at normal times.

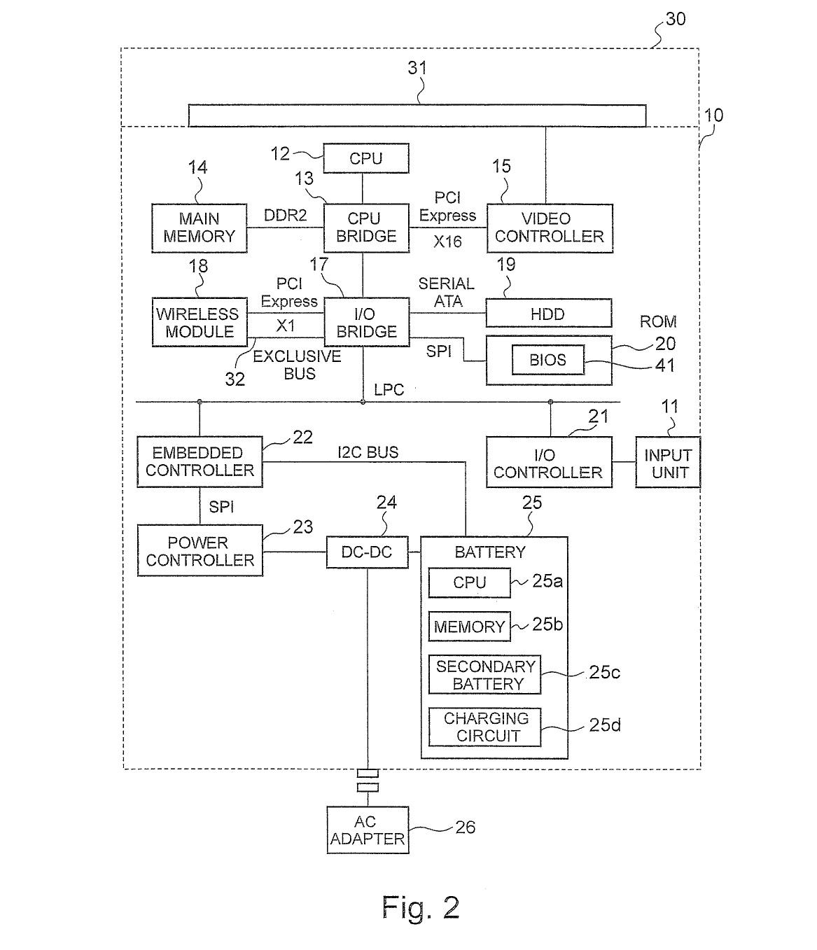

FIG. 2 is a block diagram of the hardware configuration of the laptop PC 1. As shown in FIG. 2, the laptop PC 1 includes a CPU 12, a CPU bridge 13, a main memory 14, a video controller 15, a liquid crystal display panel 31, an I/O bridge 17, a wireless module 18, a hard disk drive (HDD) 19, a ROM 20, an I/O controller 21, an input unit 11, an embedded controller 22, a power controller 23, a DC-DC converter 24, a battery 25, and an AC adapter 26.

The CPU 12 performs a function of controlling an overall operation of the laptop PC 1 with an operating system (OS) that is stored on the HDD 19 connected thereto via the CPU bridge 13 and the I/O bridge 17 and executing processes based on various kinds of programs stored in the HDD 19. The ROM 20 stores therein a BIOS 41, data, and the like. The main memory 14 is configured by a RAM, for example, and has a memory function to be used as a work area during execution of various kinds of programs by the CPU 12.

The display unit 30 includes a liquid crystal display panel 31, a backlight (not shown), an inverter (not shown) that drives the backlight, and a driver circuit that drives the liquid crystal display panel 31. The liquid crystal display panel 31 has a function of displaying menus, statuses, and display transitions associated to various kinds of processes of the CPU 12. The video controller 15 adjusts a luminance of the backlight by controlling the inverter in accordance with control of the CPU 12 and sends a video signal to the driver circuit to control display of the liquid crystal display panel 31. The wireless module 18 performs a function of connecting to a network such as the Internet and achieving a communication connection with other devices by means of infrared rays.

The input unit 11 includes a keyboard including various kinds of keys for inputting characters, commands, and the like and a slide pad for moving a cursor on a screen or selecting various kinds of menus. The I/O controller 21 detects input operations of the input unit 11 and outputs a detection result to the CPU 12.

The HDD 19 has a function of storing various kinds of programs such as, for example, an OS for controlling an overall operation of the laptop PC 1, a control program for controlling power of the laptop PC 1, a battery information display program for displaying battery information, various kinds of drivers for manipulating hardware of peripheral devices, and application programs designed for specific tasks.

The AC adapter 26 is connected to a commercial power source to convert an AC voltage to a DC voltage to be output to the DC-DC converter 24. The DC-DC converter 24 converts the DC voltage supplied from the AC adapter 26 to a predetermined voltage to be supplied to respective units and charges the battery 25.

The battery 25 is charged by the DC-DC converter 24 and supplies the charged voltage to respective units via the DC-DC converter 24. The battery 25 is used when the AC adapter 26 is not connected to a commercial power source. In the present embodiment, the battery 25 is configured so as to compliant with the Smart Battery Specification. The Smart Battery Specification is a specification that has been co-developed by Intel Inc. and Duracell Inc., which enables the outside to be informed of the remaining capacity a battery by an electronic circuit incorporated in the battery. According to the Smart Battery Specification, various kinds of battery information such as, for example, the manufacturer, the serial number, and the rated capacity are stored in a memory provided on the battery, so that users are able to acquire the various kinds of information stored in the memory by appropriately inputting various kinds of commands according to the Smart Battery Specification.

The battery 25 includes a CPU 25a that controls an overall operation of the battery 25, a nonvolatile memory 25b for storing various kinds of data including battery information, a secondary battery 25c, and a charging circuit 25d for charging the secondary battery 25c. The CPU 25a is capable of writing and reading various kinds of data to/from the memory 25b. Moreover, the CPU 25a is capable of transmit and receive various kinds of information to/from external devices. Furthermore, the CPU 25a detects, the battery current IBT, the battery voltage VBT, and the remaining battery capacity Wh, calculates the average battery remaining time t_{BTAVE} based on the detection results, and stores the calculated time in the memory 25b. In addition to the above components, additional components such as circuits or external terminals (not shown) are necessary in order to configure a battery compliant to the Smart Battery Specification. However, since these components are well known to those skilled in the art and do not constitute the spirit of the present invention, description thereof will be omitted in this specification.

The power controller 23 controls operations of the DC-DC converter 24. The embedded controller 22 controls operations of the battery 25.

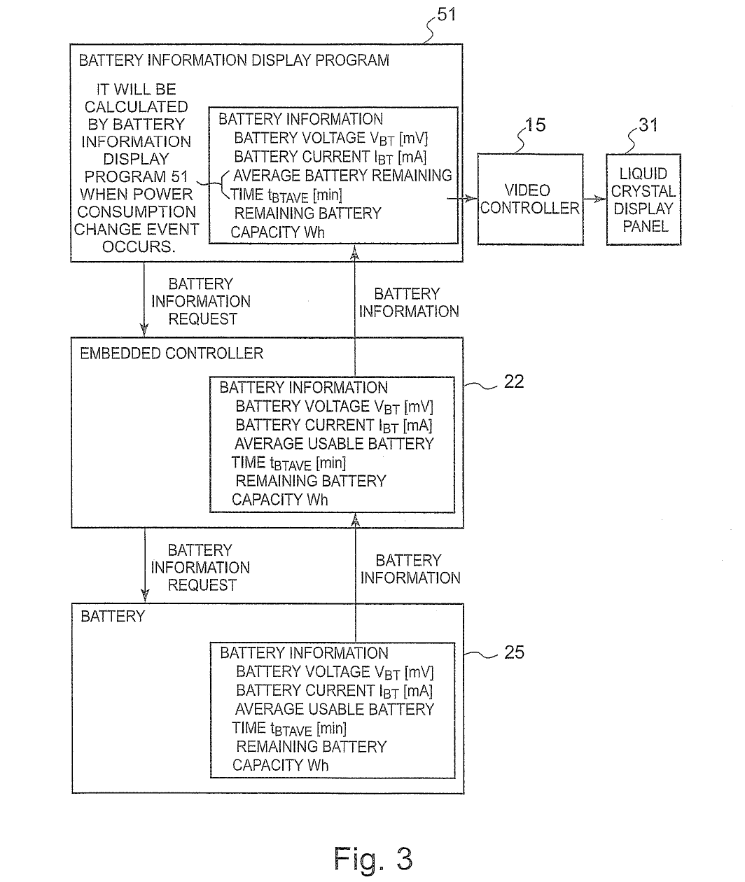

FIG. 3 is a diagram showing a functional configuration related to update and display of the battery remaining time of the laptop PC 1. In FIG. 3, the battery information display program 51 and the battery 25 constitute battery remaining time calculation and display means. In FIG. 3, the battery 25 detects battery voltage VBT, battery current IBT, and remaining battery capacity Wh at intervals of the cycle period T1 of a timer signal. Moreover, the battery 25 calculates the average battery remaining time t_{BTAVE} (={(remaining battery capacity Wh)/(battery voltage V_{BT})x(average battery current I_{BTAVE})}) at intervals of a cycle period T2 (where T2=n(T1 and n is an integer of 2 or more). Here, the average battery current I_{BTAVE} is an average of the battery current IBT detected within the cycle period T2. Since the battery voltage does not change much, the latest battery voltage is used as the battery voltage assuming that the battery voltage is constant, and the average of the battery current detected each time is used as the battery current. In this way, the average power consumption within the cycle period T2 is calculated.

Specifically, the battery voltage VBT, the battery current IBT, and the remaining battery capacity Wh are detected at intervals of T1 (=10 seconds), for example, and the average battery current I_{BTAVE} (=(I_{BT1}+I_{BT2}I_{BT3}+I_{BT4}+I_{BT5}+I_{BT6})/6) and the average battery remaining time t_{BTAVE} (=remaining battery capacity Wh/(battery voltage V_{BTG} x average battery current I_{BTAVE})) are calculated at intervals of T2 (=60 seconds). Here, the average of the detected battery voltage V_{BT} may be calculated so as to calculate the average power consumption within the cycle period T2 (=average of battery temperature V_{BT}(average battery current I_{BTAVE}).

The battery 25 the battery voltage V_{BT}, the battery current I_{BT}, the remaining battery capacity Wh, and the average battery remaining time t_{BTAVE}, which have been detected and calculated, in the memory 25b as battery information. When a battery information request is input to the battery 25 from the battery information display program 51 via the embedded controller 22, the CPU 25a transmits the battery information to the battery information display program 51 via the embedded controller 22.

Moreover, the battery information display program 51 transmits the battery information request to the battery 25 via the embedded controller 22 and acquires the battery information from the battery 25. At normal times, the battery information display program 51 acquires the battery information from the battery 25 at intervals of the cycle period T2 and updates and displays the average battery remaining time t_{BTAVE} calculated by the battery 25 on the liquid crystal display panel 31.

When a power consumption change event occurs, the battery information display program 51 acquires the battery information from the battery 25 at intervals of the cycle period T1 and updates and displays the average battery remaining time t_{BTAVE} on the liquid crystal display panel 31 in order to promptly inform users of its effect. Here, the power consumption change event refers to an event which can cause a great change in power consumption, such as, for example, a change of power-saving settings (for example, a change in settings on power options provided by Windows®), ON/OFF control of a battery-life extending function, changes in the luminance of the liquid crystal display panel 31, an attachment/removal of external devices, and a change in clock settings of a CPU.

In this case, since the average battery remaining time t_{BTAVE} is updated in the battery 25 at intervals of only the cycle period T2, the battery information display program 51 calculates the average battery remaining time t_{BTAVE} at intervals of the cycle period T1. At this time, the battery information display program 51 calculates the average battery remaining time t_{BTAVE} by calculating an average of power consumption per unit time that is the result of a sequential integration of the cycle period.

Specifically, the battery information display program 51 calculates the average battery remaining time t_{BTAVE} (=remaining battery capacity Wh/(battery voltage VBTN×average battery current I_{BTAVE}) at intervals of the cycle period T1 and displays (updates) the calculated average battery remaining time t_{BTAVE} on the liquid crystal display panel 31. Here, the average battery current I_{BTAVE}={previous average battery current I_{BTAVE}×(integration count−1)+present battery current IBT}/(integration count).

In this way, for example, when T1=10 seconds and T2=60 seconds, at normal times, the battery remaining time is not updated for 60 seconds, whereas when a user has changed the power-saving settings, the battery remaining time will be updated 10 seconds after the change is made, and the user is able to promptly recognize the effect of changing the settings. When the cycle period T2 has elapsed from the occurrence of the power consumption change event, the same process as that of the normal times is performed.

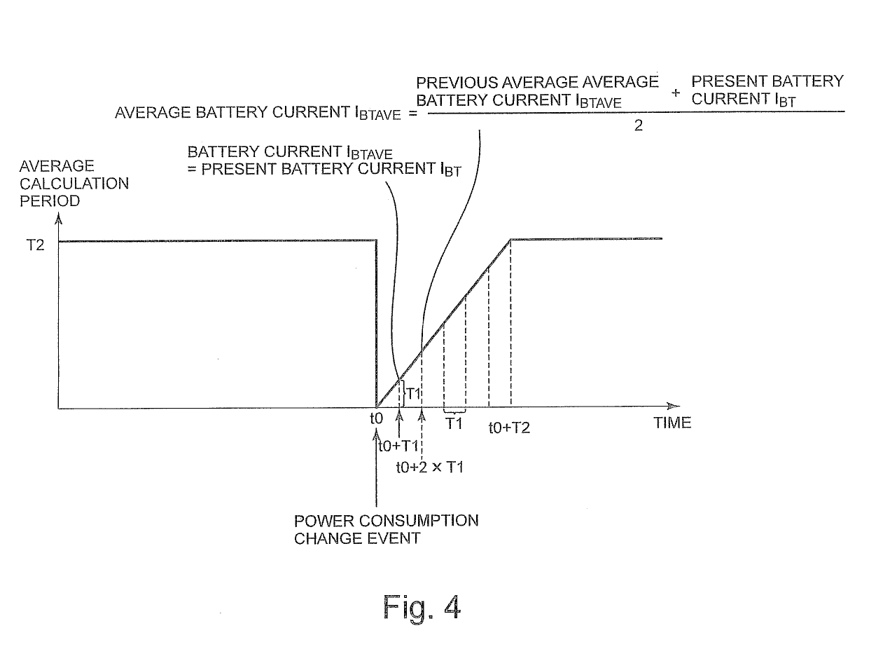

FIG. 4 is a graph illustrating the cycle period for calculating the average battery remaining time t_{BTAVE}. In FIG. 4, the horizontal axis represents time and the vertical axis represents an average calculation period.

At normal times, the average battery current within the cycle period T2 is calculated (that is, an average within the cycle period T2 of the battery current detected at intervals of the cycle period T1 is calculated). When the power consumption change event occurs, the average battery current is calculated at intervals of the cycle period T1 shorter than the cycle period T2 until the cycle period T2 elapses from the occurrence of the power consumption change event, and an average of the battery current per unit time which is the result of a sequential integration of the cycle period T1. For example, when the power consumption change event occurs at time t0, the average battery current I_{BTAVE} at time t0+T1 will be the present battery current; and the average battery current I_{BTAVE} at time t0+2(T1 will be {(previous average battery current I_{BTAVE} at t0+T1)+(present battery current IBT at t0+2(T1)}/2. The average battery current will be calculated in this way until the time reaches t0+T2. At times later than t0+T2, the average battery current within the cycle period T2 will be calculated similar to the normal times.

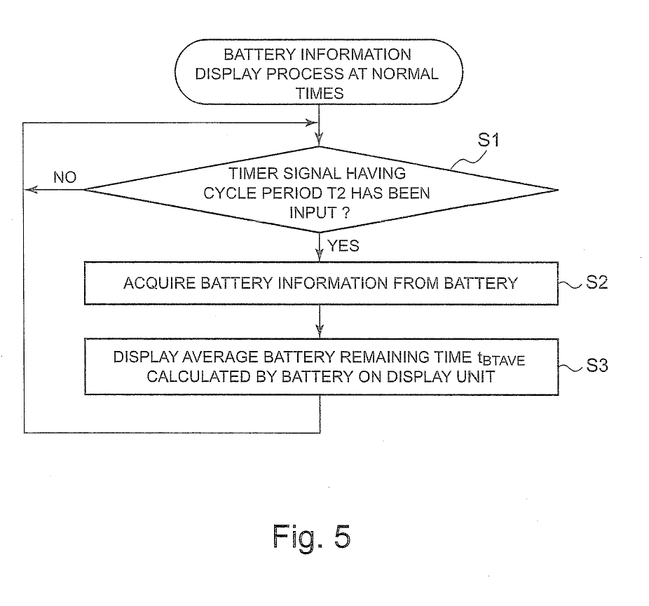

FIG. 5 is a flowchart illustrating a battery information display process at normal times which is performed by the battery information display program 51. In FIG. 5, first, when a timer signal having the cycle period T2 is input (step S1: Yes), the battery information display program 51 acquires battery information (battery current IBT, battery voltage VBT, average battery current I_{BTAVE}, remaining battery capacity Wh, and average battery remaining time t_{BTAVE}) from the battery 25 via the embedded controller 22 (step S2). Moreover, the battery information display program 51 displays the average battery remaining time t_{BTAVE} acquired from the battery 25 on the liquid crystal display panel 31 (step S3).

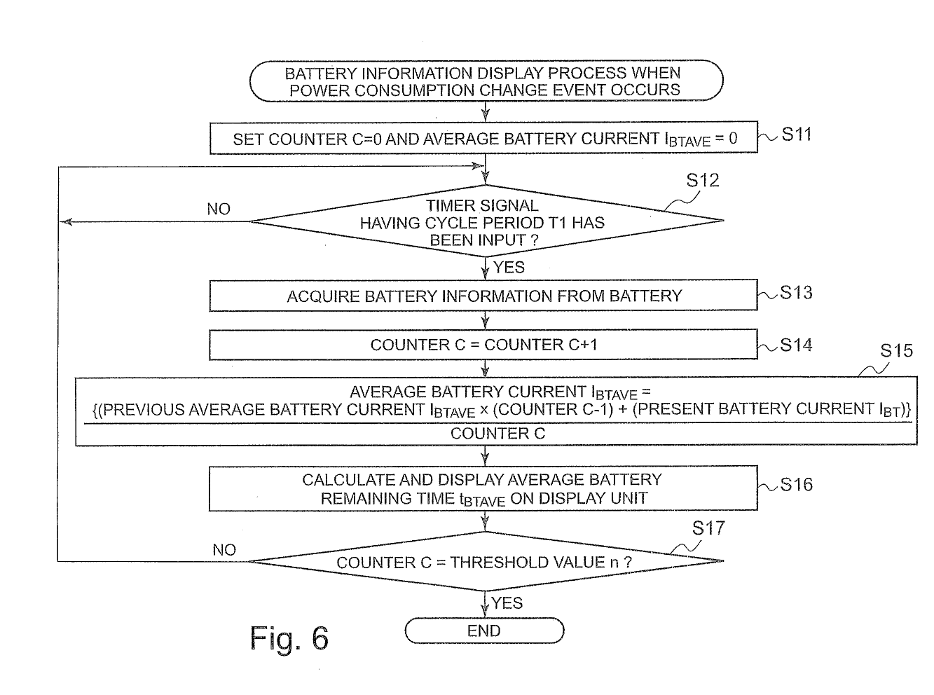

FIG. 6 is a flowchart illustrating the battery information display process performed by the battery information display program 51 when a power consumption change event occurs. In FIG. 6, first, the battery information display program 51 initializes a counter C to 0 and an average battery current I_{BTAVE} to 0 (step S11) and starts a timer having a cycle period T1. Here, the counter C represents an integration count of T1 when the battery remaining time is updated and displayed at intervals of the cycle period T1. When a timer signal having the cycle period T1 is input (step S12: Yes), the battery information display program 51 acquires the battery information (battery current IBT, battery voltage VBT, and remaining battery capacity Wh) from the battery 25 via the embedded controller 22 (step S13).

The battery information display program 51 increments the counter C by “1” (step S14). Subsequently, the battery information display program 51 calculates an average battery current I_{BTAVE} (={(previous average battery current I_{BTAVE})×(counter C−1)+present battery current IBT}/(counter C) (step S15). Then, an average battery remaining time t_{BTAVE} is calculated using the calculated average battery current I_{BTAVE} and displayed on the liquid crystal display panel 31 (step S16). After that, a determination is made as to whether or not the counter C is equal to a threshold value n (n=T2/T1) (step S17). When the counter C is different from the threshold value n (step S17: No), the flow returns to step S12. On the other hand, when the counter C is equal to the threshold value n (step S17: Yes), the flow ends here.

As described above, according to the present embodiment, the battery 25 detects the battery voltage, the battery current, and the remaining battery capacity and calculates the battery remaining time at the intervals of the first cycle period T2 based on the battery voltage, the battery current, and the remaining battery capacity. The battery information display program 51 updates and displays the battery remaining time calculated by the battery 25 on the display unit 30. Furthermore, when the power consumption change event occurs, the battery information display program 51 calculates the battery remaining time at the intervals of the second cycle period T1 shorter than the first cycle period T2 based on the battery voltage, the battery current, the remaining battery capacity detected by the battery 25, and updates and displays the calculated battery remaining time on the display unit 30. Due to this configuration, when an event occurs which can cause a great change in power consumption, it is possible to promptly inform users of its effect on the battery remaining time.

Moreover, when the battery remaining time is calculated at the intervals of the second cycle period T1, the battery information display program 51 calculates the battery remaining time by calculating an average of power consumption per unit time which is the result of a sequential integration of the cycle period T1. Therefore, it is possible to calculate the battery remaining time with high accuracy even in a short period.

Furthermore, when the power consumption change event occurs, the battery information display program 51 calculates, updates, and displays the battery remaining time at the intervals of the second cycle period T1 only for a predetermined period, and thereafter, calculates, updates, and displays the battery remaining time at the intervals of the first cycle period T2. Therefore, it is possible to reduce the load of the calculation, updating and displaying by the battery information display program 51.

Furthermore, the battery 25 performs the same processes between the normal times and the time when the power consumption change event occurs, and the battery information display program 51 calculates the battery remaining time when the power consumption change event occurs. Therefore, it is possible to calculate, update, and display the battery remaining time at shorter intervals at the time of occurrence of the power consumption change event without modifying the processes of the battery 25. It should be noted that when the power consumption change event occurs, the battery 25 may calculate the battery remaining time at the intervals of the second cycle period T1.

In the above-described embodiment, although a laptop PC has been described as an example of the electronic apparatus according to the present invention, the present invention is not limited to this but can be applied to all electronic apparatuses which are powered by a battery as a power source, such as a PDA, a portable terminal, or a digital camera.

As has been described, the present invention provides a method for displaying the remaining time of a battery.

While the invention has been particularly shown and described with reference to a preferred embodiment, it will be understood by those skilled in the art that various changes in form and detail may be made therein without departing from the spirit and scope of the invention.

What is claimed is:

1. A method comprising:
detecting battery voltage, battery current and remaining battery capacity of a battery;
determining a first battery remaining time at intervals of a first cycle period based on said battery voltage, said battery current and said remaining battery capacity;
updating and displaying said first battery remaining time on a display unit;
in response to an occurrence of a power consumption change event, determining a second battery remaining time at intervals of a second cycle period based on said battery voltage, said battery current and said remaining battery capacity, wherein said second cycle period is shorter than said first cycle period; and
updating and displaying said second battery remaining time on said display unit.

2. The method of claim 1, wherein said power consumption change event includes at least one of a change in power-saving settings, ON/OFF control of a battery-life extending function, and a change in luminance of said display unit.

3. The method of claim 1, wherein said method further includes
determining said first battery remaining time for said first cycle period by determining an average of power consumption within said first cycle period based on said battery voltage and said battery current detected within said first cycle period; and
determining said battery remaining time for said second cycle period by determining an average power consumption per unit time that is the result of a sequential integration of said second cycle period.

4. The method of claim 1, wherein said method further includes when said power consumption change event occurs, determining, updating, and displaying said battery remaining time at the intervals of said second cycle period for a predetermined period, and thereafter, determining, updating, and displaying said battery remaining time at the intervals of said first cycle period.

5. A computer-readable medium having a computer program product for displaying battery remaining time, wherein said computer-readable medium comprising:
program code for detecting battery voltage, battery current and remaining battery capacity of a battery;
program code for determining a first battery remaining time at intervals of a first cycle period based on said battery voltage, said battery current and said remaining battery capacity;
program code for updating and displaying said first battery remaining time on a display unit;
program code for, in response to an occurrence of a power consumption change event, determining a second battery remaining time at intervals of a second cycle period based on said battery voltage, said battery current and said remaining battery capacity, wherein said second cycle period is shorter than said first cycle period; and
program code for updating and displaying said second battery remaining time on said display unit.

6. The computer-readable medium of claim 5, wherein said power consumption change event includes at least one of a change in power-saving settings, ON/OFF control of a battery-life extending function, and a change in luminance of said display unit.

7. The computer-readable medium of claim 5, wherein said computer-readable medium further includes
program code for determining said first battery remaining time for said first cycle period by determining an average of power consumption within said first cycle period based on said battery voltage and said battery current detected within said first cycle period; and
program code for determining said battery remaining time for said second cycle period by determining an average power consumption per unit time that is the result of a sequential integration of said second cycle period.

8. The computer-readable medium of claim 5, wherein said computer-readable medium further includes program code for, when said power consumption change event occurs, determining, updating, and displaying said battery remaining time at the intervals of said second cycle period for a predetermined period, and thereafter, determining, updating, and displaying said battery remaining time at the intervals of said first cycle period.

9. A battery-powered electronic device comprising:
a detector for detecting battery voltage, battery current and remaining battery capacity;
a controller for
determining a first battery remaining time at intervals of a first cycle period based on said battery voltage, said battery current, and said remaining battery capacity; and
in response to a power consumption change event occurs, determining a second battery remaining time at intervals of a second cycle period shorter than said first cycle period based on said battery voltage, said battery current, and said remaining battery capacity; and
a display for displaying said first and second battery remaining time on said display unit.

10. The electronic device of claim 9, wherein said power consumption change event includes at least one of a change in power-saving settings, ON/OFF control of a battery-life extending function, and a change in luminance of said display unit.

11. The electronic device of claim 9, wherein:
said first battery remaining time for said first cycle period is determined by determining an average of power consumption within said first cycle period based on said battery voltage and said battery current detected within said first cycle period; and
said battery remaining time for said second cycle period is determined by determining an average power consumption per unit time that is the result of a sequential integration of said second cycle period.

12. The electronic device of claim 9, wherein when said power consumption change event occurs, said battery remaining time at the intervals of said second cycle period for a predetermined period is determined, updated, and displayed, and thereafter, said battery remaining time at the intervals of said first cycle period is determined, updated, and displayed.
